(19) United States
(12) Patent Application Publication
(10) Pub. No.: US 2026/0278611 A1
(43) Pub. Date: Sep. 17, 2026

(54) MULTI-LAYER RISK DEFENSE SYSTEMS AND METHODS

(71) Applicant: PayPal, Inc., San Jose, CA (US)

(72) Inventors: Shijia Zhang, Shanghai (CN); Chuling Wu, Shanghai (CN); Yan Zhang, Shanghai (CN)

(21) Appl. No.: 19/076,196

(22) Filed: Mar. 11, 2025

(51) Int. Cl. G06Q 20/40

(52) U.S. Cl. CPC G06Q 20/4016

(57) ABSTRACT

A multi-layer risk detection architecture is provided. The multi-layer risk detection architecture includes multiple layers to ensure comprehensive risk detection. At the access layer, the system generates access risk data based on access layer data, which represents at least one access flow for accessing an account of a service provider. The provisioning layer generates provisioning risk data by analyzing provisioning layer data and the previously obtained access risk data. The provisioning layer data represents at least one service flow to multiple services associated with the account. The transaction layer generates transaction risk data by evaluating transaction layer data, along with the access and provisioning risk data. The transaction layer data represents at least one transaction flow associated with the account. A risk notification is generated based on one or more of the access risk data, provisioning risk data, and transaction risk data, ensuring a multi-faceted approach to risk detection.

### FIELD OF INVENTION

The embodiments are directed to a risk detection system for online transactions, and more particularly to a multi-layer risk detection system for detecting and preventing fraudulent online transactions based on multiple data flows.

### BACKGROUND

Digital online transactions have become an integral part of modern commerce, offering convenience and efficiency for both merchants and consumers. As the volume and complexity of digital transactions increase, so does the potential for fraudulent activities, particularly in the form of account takeovers (ATO). These unauthorized accesses to legitimate accounts pose significant risks to the security and integrity of online payment systems.

Existing risk detection systems for online transactions often focus on individual checkpoints or specific types of fraud patterns. However, as fraudsters become more sophisticated, there is a growing need for more comprehensive and adaptive solutions across multiple layers and data flows in the online transaction system. Technical improvements in risk detection systems are required to address the evolving landscape of online fraud, particularly in the context of merchant accounts where the potential for damage is magnified.

### BRIEF DESCRIPTION OF FIGURES

FIG. 1 illustrates a computing environment wherein the embodiments may be implemented.

FIG. 2 illustrates a block diagram of a multi-layer risk detection system, according to some embodiments.

FIG. 3 illustrates a block diagram of an authentication cross layer, according to some embodiments.

FIG. 4 illustrates a block diagram of a monitoring cross layer, according to some embodiments.

FIG. 5 illustrates a flowchart of a method for detecting an account takeover using a multi-layer risk detection system, according to some embodiments.

FIG. 6 illustrates a block diagram of a computing system, according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

A multi-layer risk detection system provides a comprehensive approach for detecting and preventing fraudulent online transactions, with a particular focus on merchant account takeovers. This system employs a layered architecture that analyzes and evaluates account takeover (ATO) risk from data and event flows that occur at multiple stages of merchant account interactions.

In a non-limiting embodiment, the system may be specifically designed to protect merchant accounts, which can be particularly vulnerable to fraudulent activities due to their potential for high-value transactions and access to sensitive financial information. By focusing on merchant accounts, the system addresses unique challenges and risk factors associated with digital online transactions. Notably, the same or similar accounts may also apply to other types of service providers and other online accounts that facilitate transactions in an online environment.

The multi-layer risk detection system may include multiple distinct layers, including access, provisioning, and transaction layers. Each layer may analyze different aspects of account activity stemming from different types of data or event flows and generate risk data based on its specific focus. The access layer may evaluate access data flows, such as login attempts and account access patterns. The provisioning layer may evaluate service flows, such as requests for new services or changes to existing account features. The transaction layer may analyze the flow of transactions associated with the account.

The multi-layer risk detection system also includes cross-over layers, such as an authentication layer and a monitoring layer that generate authentication messages and alerts based on the risks identified at the access layer, provisioning layer, and/or transaction layer. By combining risk assessments from multiple layers, the system may provide a more comprehensive and accurate evaluation of potential fraudulent activities. This layered approach may allow for the detection of sophisticated fraud attempts directed at ATOs that might not be apparent when examining individual aspects of account activity in isolation.

The multi-layer risk defense system may represent a technical improvement over existing systems by integrating data analysis across multiple layers of account interaction. Unlike traditional systems that may focus on isolated checkpoints, this approach may enable a more holistic view of account activity. By processing and correlating data from access, provisioning, and transaction layers, the risk detection system may be capable of detecting complex fraud patterns that could otherwise go unnoticed. This multi-dimensional analysis may enhance the accuracy, efficiency, and real-time risk detection, potentially reducing false positives while improving the identification of genuine threats and ATOs. Additionally, the system's ability to adapt and learn from new patterns through its machine learning component may provide ongoing improvements in fraud detection capabilities, allowing it to evolve alongside emerging threat vectors in the digital online transactions space.

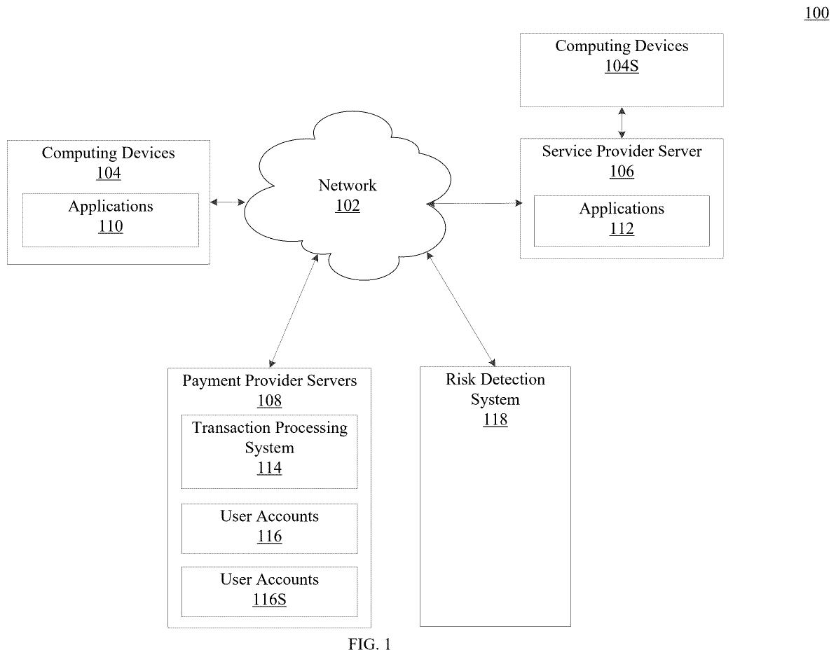

FIG. 1 is an exemplary computing environment 100 where embodiments can be implemented. Computing environment 100 includes a network 102. Network 102 may be implemented as a single network or a combination of multiple networks. For example, in various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104, service provider server(s) 106, and payment provider server(s) 108. Computing devices 104 may be portable and non-portable electronic devices under the control of a user and configured to transmit, receive, and manipulate data from service provider server(s) 106 and payment provider server(s) 108 over network 102. Example computing devices 104 include desktop computers, laptop computers, tablets, smartphones, wearable computing devices, eyeglasses that incorporate computing devices, implantable computing devices, etc.

Computing devices 104 may include one or more applications 110. Applications 110 may be pre-installed on the computing devices 104, installed on the computing devices 104 using portable memory storage devices, such as compact disks or thumb-drives, or be downloaded to the computing devices 104 from service provider server(s) 106 and/or payment provider server(s) 108. Applications 110 may execute on computing devices 104 and receive instructions and data from a user, from service provider server(s) 106, and payment provider server(s) 108.

Example applications 110 may be payment transaction applications. Payment transaction applications may be configured to transfer money world-wide, receive payments for goods and services, manage money spending, etc. Further, applications 110 may be under an ownership or control of a payment service provider, such as PAYPAL®, Inc. of San Jose, CA, USA, a telephonic service provider, a social networking service provider, and/or other service providers. Applications 110 may also be analytics applications. Analytics applications perform business logic, provide services, and measure and improve performance of services and functions of other applications that execute on computing devices 104 based on current and historical data. Applications 110 may also be security applications for implementing client-side security features, programmatic client applications for interfacing with appropriate application programming interfaces (APIs) over network 102, communication applications, such as email, texting, voice, and instant messaging applications that allow a user to send and receive emails, calls, texts, and other notifications through network 102, and the like. Applications 110 may be location detection applications, such as a mapping, compass, and/or global positioning system (GPS) applications, social networking applications and/or merchant applications. Additionally, applications 110 may be service applications that permit a user of computing device 104 to receive, request and/or view information for products and/or services and permit the user to purchase the selected products and/or services.

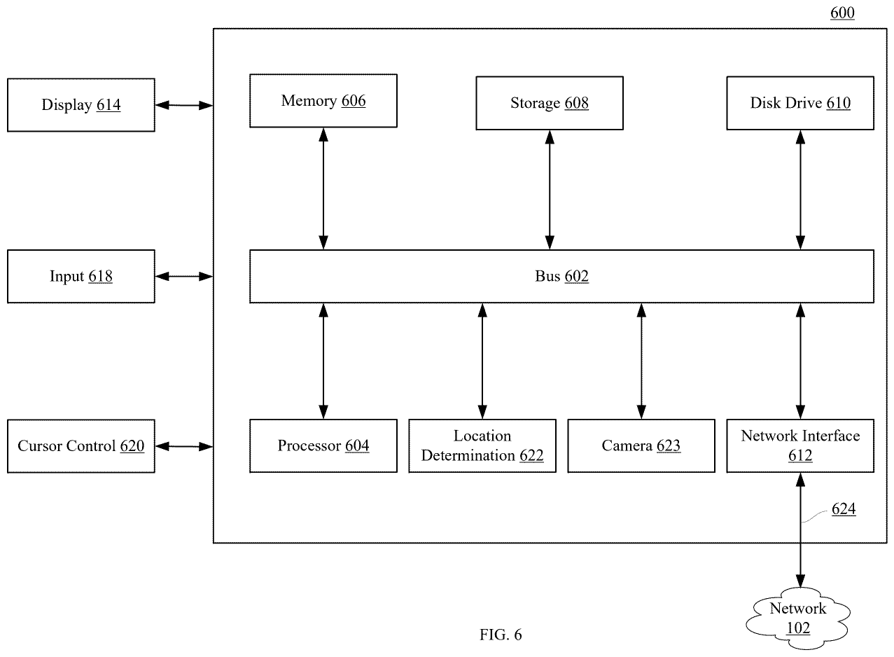

In an embodiment, applications 110 may utilize numerous components included in computing device 104 to receive input, store and display data, and communicate with network 102. Example components are discussed in detail in FIG. 6.

As discussed above, one or more service provider servers 106 may be connected to network 102. Service provider server 106 may also be maintained by a service provider, such as PAYPAL®, a telephonic service provider, social networking service, and/or other service providers. Service provider server 106 may be software that executes on a computing device configured for large scale processing and that provides functionality to other computer programs, such as applications 110 and applications 112 discussed below.

In an embodiment, service provider server 106 may initiate and direct execution of applications 112. Applications 112 may be counterparts to applications 110 executing on computing devices 104 and may process transactions at the requests of applications 110. For example, applications 112 may be financial services applications configured to transfer money world-wide, receive payments for goods and services, manage money spending, etc., that receive message from the financial services applications executing on computing device 104. Applications 112 may be security applications configured to implement client-side security features or programmatic client applications for interfacing with appropriate application programming interfaces (APIs) over network 102. Applications 112 may be communication applications that perform email, texting, voice, and instant messaging functions that allow a user to send and receive emails, calls, texts, and other notifications over network 102. In yet another embodiment, applications 112 may be location detection applications, such as a mapping, compass, and/or GPS applications. In yet another embodiment, applications 112 may also be incorporated into social networking applications and/or merchant applications.

In an embodiment, applications 110 and applications 112 may process transactions on behalf of a user. In some embodiments, to process transactions, applications 110, 112 may request payments for processing the transactions via payment provider server(s) 108. For instance, payment provider server 108 may be a software application that is configured to receive requests from applications 110, 112 that cause the payment provider server 108 to transfer funds of a user using application 110 to service provider associated with application 112. Thus, applications 110 and 112 may receive user data, including user authentication data, for processing any number of electronic transactions, such as through payment provider server 108.

In an embodiment, payment provider servers 108 may be maintained by a payment provider, such as PAYPAL®. Other payment provider servers 108 may be maintained by or include a merchant, financial services provider, credit card provider, bank, and/or other payment provider, which may provide user account services and/or payment services to a user. Although payment provider servers 108 are described as separate from service provider server 106, it is understood that one or more of payment provider servers 108 may include services offered by service provider server 106 and vice versa.

Each payment provider server 108 may include a transaction processing system 114. Transaction processing system 114 may correspond to processes, procedures, and/or applications executable by a hardware processor. In an embodiment, transaction processing system 114 may be configured to receive information from one or more applications 110 executing on computing devices 104 and/or applications 112 executing on service provider server 106 for processing and completion of financial transactions. Financial transactions may include financial information corresponding to user debit/credit card information, checking account information, a user account (e.g., payment account with a payment provider server 108), or other payment information. Transaction processing system 114 may complete the financial transaction for the purchase request by providing payments to applications 112 executing on service provider server 106.

Payment provider server 108 may also include user accounts 116. Each user account 116 may be established by one or more users using applications 110 with payment provider server 108 to facilitate payment for goods and/or services offered by applications 112. User accounts 116 may include user information, such as name, address, birthdate, payment/funding information, travel information, additional user financial information, and/or other desired user data. In a further embodiment, user accounts 116 may be stored in a database or another memory storage described in detail in FIG. 6. In some instances, payment provider server 108 may also include user accounts 116S. User accounts 116S may be established on behalf of service providers or merchants that are associated with applications 112 executing on service provider server 106, and that may be subject to ATOs.

In some embodiments, computing devices 104 that execute applications 110, payment providers servers 108, and applications 112 that execute on server provider servers 106, and the connection of these components over network 102 may operate in computing environment 100. A user may use application 110 of computing device 104 and service providers may use computing devices 104S to interact with the computing environment 100. For example, users and service providers may enter user credentials into a graphical user interface that may be displayed on applications 110, 112 and log-in or access the computing environment 100. A user may use application 110 to perform actions, such as browse products or services available on application 110, select one or more products or services, and/or purchase the selected one or more products or services. Similarly, a service provider may use application 112 to access services available by payment provider server 108 or by transaction processing system 114. The interactions may create actions or events that may be logged by applications 110, 112 or elsewhere in the computing environment 100. An event may include data or features associated with the event, such as user access information, products or services browsed, stored, or requested, transaction information, whether a transaction has been initiated or completed, etc.

The more users and service providers interact with the computing environment 100, the more events and data flows with various features are generated. Initially, the events may include credential and account access information. The events may also include different products or services selected by the user and or service provider for purchase and/or subscription. Finally, the events may also include various transactions that occur among users, service providers, and/or payment provider servers in computing environment 100.

Computing environment 100 may also include a multi-layered risk detection system 118. Risk detection system 118 may identify fraud, risk of fraud, and/or security breaches that may occur at payment provider servers 108 that indicate an ATO. In particular, risk detection system 118 may identify fraud, risk of fraud, and/or security breaches that may compromise accounts 116S of merchants and/or service providers.

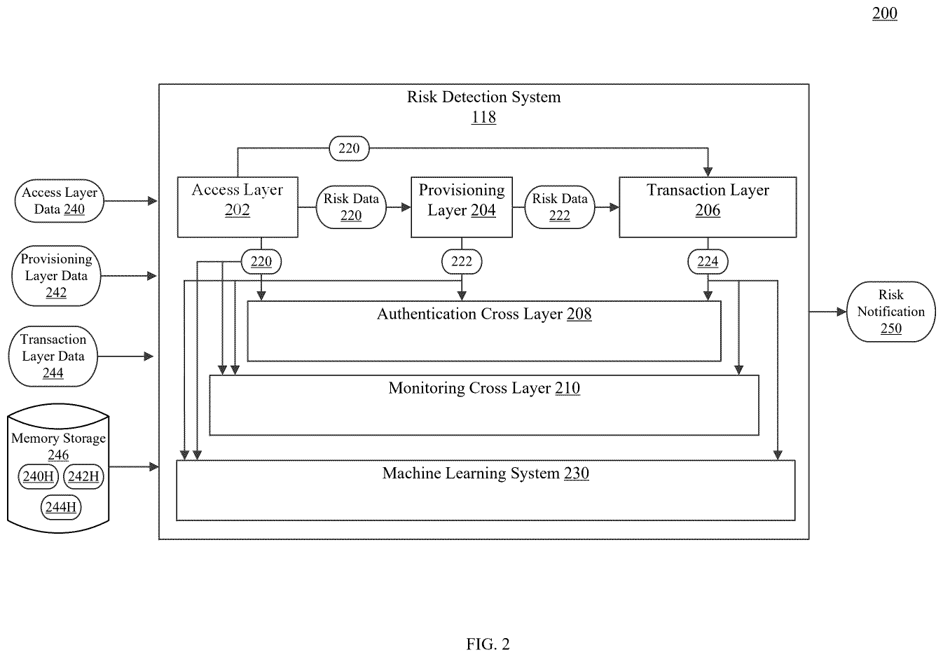

FIG. 2 illustrates a block diagram of a system architecture 200 for a multi-layered risk detection system 118, according to some embodiments. The risk detection system 118 may comprise an access layer 202, a provisioning layer 204, and a transaction layer 206. In some cases, the risk detection system 118 may also include two cross layers: an authentication cross layer 208 and a monitoring cross layer 210. These cross layers 208, 210 may span across the layers 202-206 and provide additional fraud detection, notification, and tracking capabilities.

The access layer 202 of the risk detection system 118 may receive access layer data 240 and generate access risk data 220. The access layer data 240 may represent event flows for accessing accounts 116S, such as a service provider or a merchant accounts. The access layer 202 may be designed to identify suspicious login attempts and profile changes and encode this information in access risk data 220.

Access layer 202 may be configured with models that are customized with merchant login and profile change strategy. The models may be swapped and updated on demand. For example, the access layer 202 may receive access layer data 240 that may include event flows identifying login attempt timestamps, Internet Protocol (IP) addresses used for login attempts, device information associated with login attempts, frequency of login attempts, changes to account profile information, password reset requests, and two-factor authentication responses. Access layer 202 may include models that analyze various aspects of account access attempts to detect potential unauthorized access or suspicious activities. For instance, the access layer 202 may identify patterns such as multiple failed log-in attempts from unfamiliar IP addresses or sudden changes to critical account information as potential indicators of unauthorized access attempts. Access layer 202 may also identify unusual changes to a profile that is associated with user account 116S.

Access layer 202 may generate access risk data 220 that includes the results of its analysis. Risk data 220 may include account level flags, risk assessment data (RADD), or counter variables. Once computed, access layer 202 may embed risk data 220 into embeddings or data structures and pass risk data 220 to downstream layers 204, 206.

Access layer 202 may also cause risk detection system 118 to generate a risk notification 250. Risk notification 250 may be transmitted to payment provider server 108 and indicate a potential likelihood of fraud or risk associated with one of user accounts 116S. Additionally or alternatively, risk detection system 118 may also transmit risk notification 250 to computing device 104S of the service provider shown in FIG. 1.

Provisioning layer 204 of the risk detection system 118 may be configured to generate provisioning risk data 222 based on provisioning layer data 242 and the access risk data 220 received from the access layer 202. The provisioning layer 204 may be designed to evaluate access to services or changes to services associated with user account 116S. For example, the provisioning layer data 242 may include event and/or data flows associated with applications for merchant products such as card processing with virtual terminal capabilities, mass payment services, or requests for merchant credit from payment provider server 108, and the like.

Provisioning layer 204 may analyze the provisioning layer data 242 in conjunction with the access risk data 220 to identify potential risks associated with service provisioning. For instance, the provisioning layer 204 may evaluate whether a request for a new service aligns with the historical behavior and profile associated with user account 116S. Provisioning layer 204 may also evaluate whether unusual or new service or merchant product activity is occurring or merchant credit is being requested, such as instances where multiple applications for merchant credit are being submitted, applications being submitted from IP address of computing devices 104S from new locations, or from multiple computing devices 104S from the same location, applications being submitted for loans above a configurable loan threshold, and the like.

Provisioning layer 204 may also incorporate step-up capabilities in merchant service provisioning. This feature may enable tiered real-time ATO action without negatively impacting user experience. For example, if a high-risk request is detected, the provisioning layer 204 may trigger additional authentication steps before approving the service, issue risk notification 250 to the service provider, and the like.

In some cases, the provisioning layer 204 may be the first line of ATO risk control established in merchant product provisioning and credit application evaluation. This is because provisioning layer 204 goes beyond simply evaluating eligibility of a merchant or a service provider, as in conventional systems. Instead, provisioning layer 204 assesses the likelihood of account compromise when otherwise eligible fraudulent actors attempt to apply for products or services associated with user account 116S.

In some instances, provisioning risk data 222 generated by the provisioning layer 204 may be passed to the transaction layer 206 for further analysis and integration into subsequent risk assessments. Passing provisioning risk data 222 to transaction layer 206 may contribute to a more comprehensive risk evaluation within transaction layer 206. Additionally, provisioning risk data 222 may also be transmitted to authentication cross layer 208 and monitoring cross layer 210.

In some cases, the provisioning layer 204 may generate risk notification 250 based on its analysis of the provisioning risk data 222 and access risk data 220. This risk notification 250 may be triggered when the provisioning layer 204 detects potentially suspicious activity related to service requests or changes associated with user account 116S. For example, if the provisioning layer 204 identifies an unusual pattern of service applications or requests for credit that deviate significantly from the account's historical behavior, it may generate a risk notification 250. This notification may be transmitted to the payment provider server 108 as part of a step-up functionality or directly to the computing device 104S associated with the service provider. The risk notification 250 generated by the provisioning layer 204 may include details about the detected anomaly, such as the type of service request, the time of the request, and any other relevant contextual information, such as suspicious log-in attempts identified from risk data 220 that may help in assessing the potential risk.

The transaction layer 206 may receive transaction layer data 244. Additionally, transaction layer 206 may receive the access risk data 220 from access layer 202 and/or provisioning risk data 222 from the provisioning layer 204 and combine it with transaction layer data 244. The transaction layer data 244 may represent transaction flows from digital transactions associated with the user account 116S. In some cases, the transaction layer data 244 may represent various types of transactions conducted through the user account 116S. For example, the transaction layer data 244 may include information about receiving payments, depositing funds, and withdrawing or transferring money from the account 116S that may be a result of transactions with user or with other service providers or merchants. In another example, transaction layer 206 may analyze patterns in the frequency, amount, and destination of transactions. Sudden changes in transaction patterns, such as unusually large deposits, withdrawals or transfers to new recipients or deposits into existing user account 116S, may be flagged as potential indicators of an ATO. In another example, series of rapid deposits may indicate followed by immediate large withdrawals may indicate of an ATO. Unusual movement between different merchant accounts 116S may also indicate an ATO.

The transaction layer 206 may process transaction layer data 244 in conjunction with the access risk data 220 and provisioning risk data 222 to generate transaction risk data 224. Transaction risk data 224 may identify risk or fraud that corresponds to transactions passing through user account 116 in payment provider server 108. Additionally, transaction risk data 224 may identify risk or fraud that may occur when user account 116S receives funds from the transaction, rather than when user account 116S is transmitting funds. This may be particularly beneficial, when user account 116S may receive funds from other compromised user accounts 116 or receive a credit loan from service provider server 106.

The transaction layer 206 may incorporate analytical models to evaluate the transaction flows. In some cases, the risk detection system 118 may utilize Multilayer Perceptron (MLP) and Tab Transformer models for transaction-level ATO detection. Multilayer Perceptron (MLP) models may consist of multiple layers of interconnected nodes, with each node using an activation function to process inputs and pass outputs to the next layer. Tab Transformer models may utilize self-attention mechanisms to process tabular data, allowing the model to capture complex relationships between different features in the transaction layer data 244. These machine learning models may be trained to recognize patterns and anomalies in transaction layer data 244 that could indicate unauthorized account access or fraudulent activities.

Transaction layer 206 may generate risk notification 250. Risk notification 250 may be triggered when the transaction layer 206 detects potentially suspicious activity related to transaction patterns or behaviors associated with user account 116S. Risk notification 250 may be transmitted to the payment provider server 108 or directly to the computing device 104S associated with the service provider. In some cases, the risk notification 250 generated by the transaction layer 206 may include details about the detected anomaly, such as the type of transaction, whether a transaction results from a credit application, the amount involved, the time of the transaction, and other relevant contextual information that may assist in assessing the potential risk.

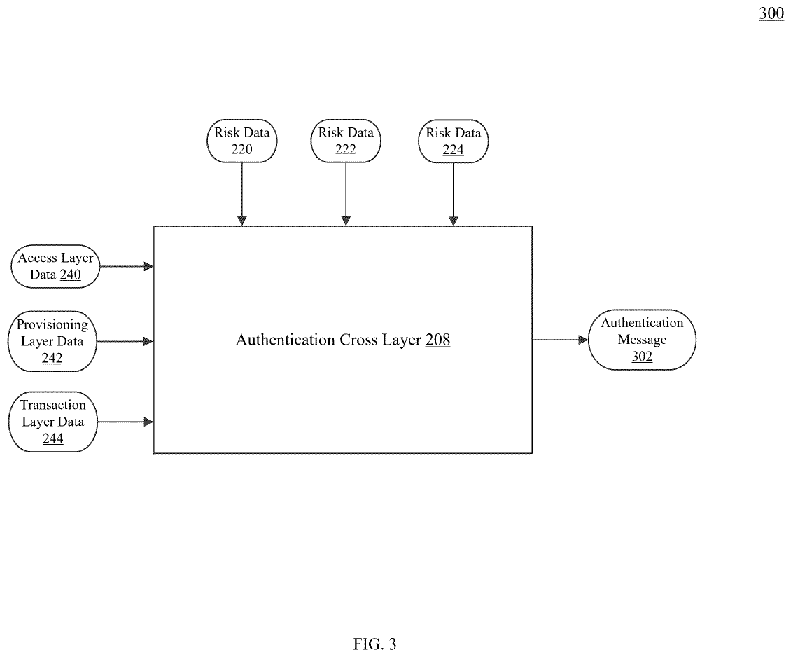

As discussed above, the risk detection system 118 may include an authentication cross layer 208 that interacts with the access layer 202, provisioning layer 204, and transaction layer 206. FIG. 3 is a diagram 300 of an authentication cross layer 208, according to some embodiments. As illustrated in FIG. 3, authentication cross layer 208 may receive access risk data 220, provisioning risk data 222, and transaction risk data 224 from the respective layers 202, 204, and 206. Additionally, authentication cross layer 208 may also receive access layer data 240, provisioning layer data 242, and/or transaction layer data 244.

The authentication cross layer 208 may analyze patterns and anomalies across all three layers 202-206 to identify potential unauthorized access attempts. For example, the authentication cross layer 208 may detect a combination of suspicious login attempts from the access layer 202, unusual service requests from the provisioning layer 204, and atypical transaction patterns from the transaction layer 206. When such a combination is detected, the authentication cross layer 208 may generate an authentication message 302 indicating a potential account takeover. The authentication message 302 may indicate an unauthorized access to the account 116S which is indicative of the ATO.

In some cases, the risk detection system 118 may transmit the authentication message 302 to an electronic address associated with the account 116S. For instance, the authentication message 302 may be sent to a corporate electronic mail domain associated with account 116S. This approach may leverage the corporate electronic mail domain as an efficient merchant authentication method.

The authentication message 302 may trigger a response on computing device 104S associated with the account 116S discussed in FIG. 1. In some cases, a computing device 104S may automatically activate an electronic message application in response to receiving the authentication message 302. This activation may prompt the account user to review and respond to the potential ATO, respond to an authentication request in authentication message 302, perform two-factor authentication, and the like.

By integrating data from the access layer data 240, provisioning layer data 242, and transaction layer data 244, the authentication cross layer 208 may provide a comprehensive approach to detecting and responding to potential ATO attempts during different workflows that interact with the account 116S. This multi-layered authentication process may enhance the security of accounts 116S by identifying complex fraud patterns that may not be apparent when examining individual layers in isolation.

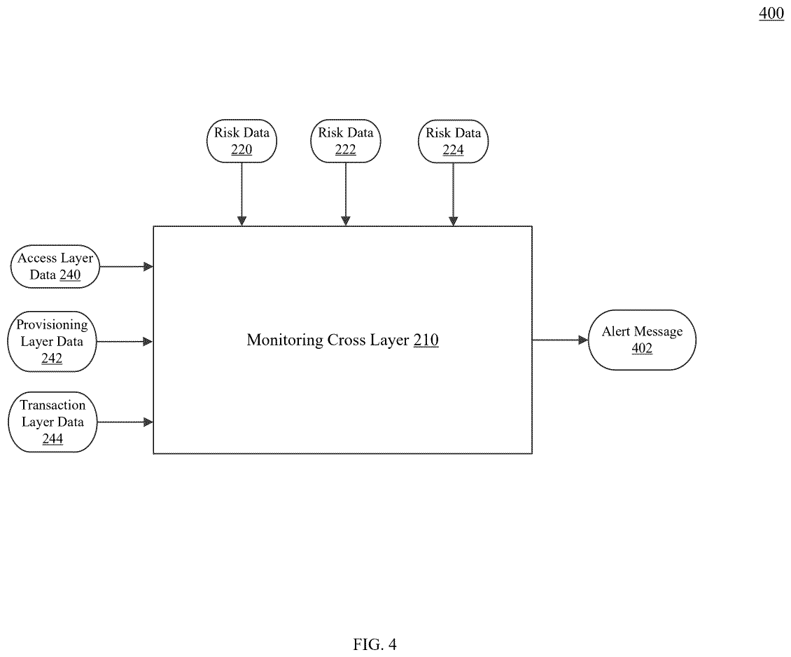

The risk detection system 118 may include a monitoring cross layer 210 as part of the system architecture 200. FIG. 4 is a diagram 400 illustrating a monitoring cross layer 210, according to some embodiments. Monitoring cross layer 210 may receive inputs with data from various data flows, including access layer data 240, provisioning layer data 242, and transaction layer data 244. Additionally, monitoring cross layer 210 may receive outputs from access layers 202, provisioning layer 204, and transaction layer 206 which may include access risk data 220, provisioning risk data 222, and transaction risk data 224.

The monitoring cross layer 210 may generate a score card. The score card may include scores that track the ATO risk of one or more accounts 116S. The scores may leverage profile and behavior change data included in risk data 220-224. In some cases, the scores in the score card may be automatically calculated and transmitted to service providers in alert messages 402. The risk score may indicate a probability that the account has been taken over or is at a risk of being taken over. In some instances, for accounts 116S with risk score(s) higher than a predetermined threshold, monitoring cross layer 210 may transmit an alert for manual review by the service provider or by payment provider server 108. Alert message 402 may be transmitted to a service or merchant provider associated with user account(s) 116S.

In some cases, the monitoring cross layer 210 may regenerate a new alert message 402 at predefined time intervals. This new alert message 402 may be based on updated access risk data 220, provisioning risk data 222, and transaction risk data 224 as updated data flows become available to layers 202-206. This regular updating may ensure that the risk assessment remains current and reflects the most recent account activity of user account 116S.

In some instances, alert message 402 may be displayed in a user interface of computing device 104S. This user interface may provide a visual representation of the current risk status associated with one or more account 116S associated with a merchant or a service provider. The risk detection system 118 may also include automatic notification templates for keeping merchants informed of account activity. These templates may be designed to display unusual account activity. The templates may be configurable and be included in alert message 402. In some instances, alert message 402 may request service provider or merchant acknowledgement via the user interface. The acknowledgement may be automatic, e.g., upon receipt of alert message 402, upon activation of the user interface, or upon affirmative input from the merchant. This feature may help to further automate the alerting process and establish a feedback loop with the service provider or the merchant.

Going back to FIG. 2, the risk detection system 118 may include a machine learning system 230. Machine learning system 230 may be trained to analyze the access risk data 220, the provisioning risk data 222, and the transaction risk data 224 to identify patterns indicative of fraudulent activity associated with the user account 116S, including account ATOs. In some cases, the machine learning system 230 may identify patterns such as unusual access patterns, atypical service requests, anomalous transaction flows, temporal anomalies, cross layer correlations. The machine learning system 230 may identify unusual patterns by detecting login attempts and/or profile changes from unfamiliar locations or devices that deviate from the merchant's typical access behavior. The machine learning system 230 may identify atypical service requests by flagging flag requests for new services, new applications, new loans, or changes to existing account features that are inconsistent with the merchant's historical provisioning patterns. The machine learning system 230 may identify transaction patterns that deviate from the merchant's usual business operations, such as sudden increases in transaction volume or changes in typical recipient profiles. The machine learning system 230 may identify temporal anomalies by detecting unusual timing patterns across different layers, such as rapid sequences of account access, service changes, and transactions that are atypical for the merchant. The machine learning system 230 may identify cross layer correlations by identifying suspicious correlations between activities in different layers that, when viewed together, suggest potential fraudulent behavior.

The machine learning system 230 may be trained using historical data stored in memory storage 246. Memory storage 246 may be a database or another memory storage conducive to storing and retrieving large amounts of data which is discussed in FIG. 6. This training data may include historical access layer data 240H, historical provisioning layer data 242H, and historical transaction layer data 244H. In some cases, the machine learning system 230 may utilize supervised learning techniques, where historical access layer data 240H, provisioning layer data 242H, and transaction layer data 244H are labeled as known instances of fraudulent and non-fraudulent activities. The machine learning system 230 may also employ unsupervised learning methods to identify new patterns or anomalies in the data that may not have been previously recognized. As new data 240H-244H is continuously added to the memory storage 246, the machine learning system 230 may periodically retrain or update its models to adapt to evolving fraud patterns and merchant behaviors. This ongoing learning process may enable the risk detection system 118 to improve its accuracy and effectiveness over time in identifying potential fraudulent activities across multiple layers of the system architecture 200.

In some instances, machine learning system 230 may operate together with access layer 202, provisioning layer 204, and/or transaction layer 206, and cross layers 208-210. In other instances, machine learning system 230 may function as a secondary or a back-up system for detecting ATO in user accounts 116S, thus offering an additional layer of protection within risk detection system 118.

The machine learning system 230 may employ various types of machine learning models and algorithms to perform its analysis. In some cases, the machine learning system 230 may include a large language model (LLM) for processing and understanding complex textual data related to account activities. The LLM may be capable of identifying subtle linguistic patterns in communication or transaction descriptions that could be indicative of fraudulent behavior. Additionally or alternatively, the machine learning system 230 may incorporate Bidirectional Encoder Representations from Transformers (BERT) models. BERT models may be particularly useful for understanding the context and relationships between different data points across the access layer 202, provisioning layer 204, and transaction layer 206. This contextual understanding may allow the machine learning system 230 to detect sophisticated fraud patterns that may not be apparent when analyzing data from each layer in isolation. The machine learning system 230 may also utilize other types of generative AI systems. These may include, but are not limited to, Generative Adversarial Networks (GANs) for simulating potential fraud scenarios, and Variational Autoencoders (VAEs) for anomaly detection in high-dimensional data spaces.

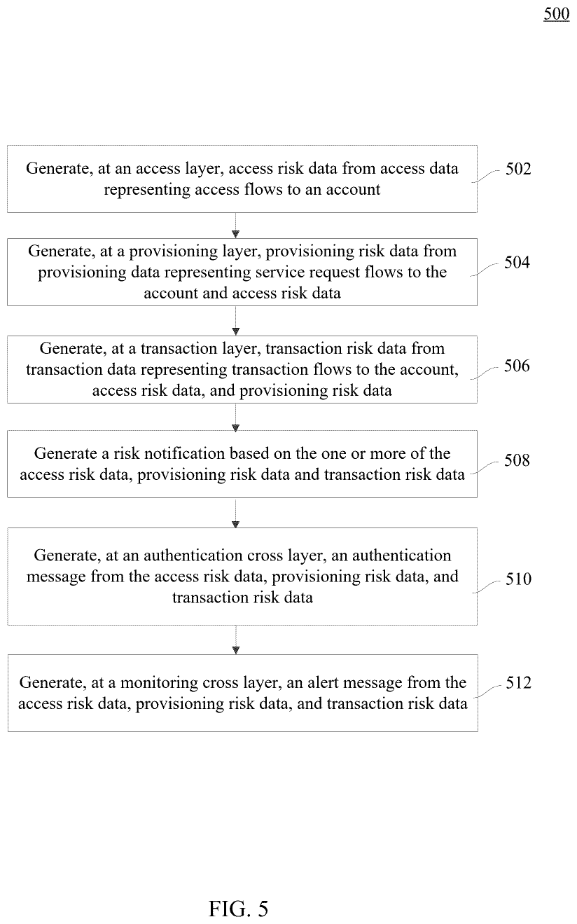

FIG. 5 illustrates a method 500 for detecting using account takeover with the risk detection system 118, according to some embodiments. Method 500 may be performed using hardware and/or software components described in FIGS. 1-4. Note that one or more of the operations may be deleted, combined, or performed in a different order as appropriate. Notably, method 500 may occur multiple times as different actions or events are generated in computing environment 100.
At operation 502, access risk data is generated at access layer 202. For example, access layer 202 may receive access layer data 240 that represents login attempts, profile changes, or other account access activities to generate access risk data 220. Access risk data 220 may be transmitted to provisioning layer 204 and/or cross layers 208 and 210. Access risk data 220 may identify a ATO of user account 116S.
At operation 504, provisioning risk data 222 is generated at the provisioning layer 204. The provisioning layer 204 may receive provisioning layer data 242 and access risk data 220 and use provisioning layer data 242 and access risk data 220 to generate provisioning risk data 222. Provisioning layer data 242 may represent service requests or account changes originating at account 116S. Provisioning risk data 222 may represent risk associated with the service requests and account changes and may identify an ATO of user account 116S based on irregular service requests may using user account 116S. An example service request may be a request for a loan for an unusual amount from user account 116S, or multiple requests for a loan from an unknown computing device 104.
At operation 506, transaction risk data is generated at transaction layer 206. The transaction layer 206 may receive transaction layer data 244 as well as access risk data 220, and provisioning risk data 222 to assess risks related to transactions that are associated with user account 116S. Transaction layer data 244 may represent movement of funds to user account 116S and from user account 116 of consumers and from accounts 116S of the same or different service providers. Transaction risk data 224 may represent ATO risk associated with the movement of funds at the user account 116S.
At operation 508, a risk notification may be generated. For example, access layer 202, provisioning layer 204 and/or transaction layer 206 may generate one or more risk notifications 250. Although for simplicity purposes operation 508 is shown after operation 506, operation 508 may occur during and/or after operations 502, 504, and 506. Risk notification 250 may be transmitted to computing device 104S of a merchant or service provider or to other components in computing environment 100, such as service provider server 106 and/or payment provider server 108 and may notify the payment provider server 108, service provider server 106, and or computing device 104S of a potential ATO event occurring at user accounts 116S of a service provider.
At operation 510, an authentication message 302 is generated. For example, the authentication cross layer 208 may use the access risk data 220, provisioning risk data 222, and transaction risk data 224 to determine whether to re-authenticate the service provider using authentication message 302. The authentication message 302 may be transmitted using electronic mail to an authorized email account of the service provider.
At operation 512, an alert message is generated. For example, monitoring cross layer 210 may use the access risk data 220, provisioning risk data 222, and transaction risk data 224 to generate an alert message 402. The alert message 402 may include a score or a score card based on the access risk data 220, provisioning risk data 222, and transaction risk data 224 indicative of an ATO of user account(s) 116S which may provide an overall risk status for the account(s) 116S.

Referring now to FIG. 6 an embodiment of a computer system 600 suitable for implementing, the systems and methods described in FIGS. 1-5 is illustrated.

In accordance with various embodiments of the disclosure, computer system 600, such as a computer and/or a server, includes a bus 602 or other communication mechanism for communicating information, which interconnects subsystems and components, such as a processing component 604 (e.g., processor, micro-controller, digital signal processor (DSP), graphics processing unit (GPU), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT or LCD), an input component 618 (e.g., keyboard, keypad, or virtual keyboard), a cursor control component 620 (e.g., mouse, pointer, or trackball), a location determination component 622 (e.g., a Global Positioning System (GPS) device as illustrated, a cell tower triangulation device, and/or a variety of other location determination devices known in the art), and/or a camera component 623. In one implementation, the disk drive component 610 may comprise a database having one or more disk drive components.

Logic may be encoded in a computer readable medium, which may refer to any medium that participates in providing instructions to the processing component 604 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 600. In various other embodiments of the disclosure, a plurality of the computer systems 600 coupled by a communication link 624 to the network (e.g., such as a LAN, WLAN, PTSN, and/or various other wired or wireless networks, including telecommunications, mobile, and cellular phone networks) may perform instruction sequences to practice the disclosure in coordination with one another.

The computer system 600 may transmit and receive messages, data, information and instructions, including one or more programs (i.e., application code) through the communication link 624 and the network interface component 612. The network interface component 612 may include an antenna, either separate or integrated, to enable transmission and reception via the communication link 624. Received program code may be executed by processor 604 as received and/or stored in disk drive component 610 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

A number of implementations have been described. Nevertheless, it will be understood that various modifications may be made without departing from the spirit and scope of the disclosure. Accordingly, other implementations are within the scope of the following claims.

What is claimed is:

1. A system, comprising:
at least one memory for storing a multi-layer risk detection architecture including an access layer, a provisioning layer, and a transaction layer;
at least one processor coupled to the at least one memory and configured to:
generate, at the access layer, access risk data based on access layer data, wherein the access layer data represents at least one access flow for accessing an account of a service provider over a network and the access layer data is associated with one or more login attempts to the account, the data comprising one or more of a number of login attempts, one or more Internet Protocol addresses from where the one or more login attempts originated, and device information associated with the one or more login attempts;
embed the access risk data generated from the access layer data into embedded access risk data;
generate, at the provisioning layer, provisioning risk data based on provisioning layer data and the embedded access risk data, wherein the provisioning layer data represents at least one service flow to a plurality of services associated with the account;
embed the provisioning risk data into embedded risk data;
generate at the transaction layer, transaction risk data based on transaction layer data, the embedded access risk data, and the embedded provisioning risk data, wherein the transaction layer data represents at least one transaction flow associated with the account;
identify, by passing one or more of the embedded access risk data, the embedded provisioning risk data, and the transaction risk data through layers of a machine learning model, patterns indicative of fraudulent activity; and
generate a risk notification based on the patterns.

2. The system of claim 1, wherein the processor is further configured to:
receive, at an authentication cross layer, the access risk data, the provisioning risk data, and the transaction risk data; and
generate, at the authentication cross layer, an authentication message based on one or more of the access risk data, the provisioning risk data, and the transaction risk data indicating an unauthorized access to the account.

3. The system of claim 2, further comprising:
transmitting the authentication message to an electronic address associated with the account, wherein a computing device activates an electronic message application in response to receiving the authentication message.

4. The system of claim 1, further comprising:
receive, at a monitoring cross layer, the access risk data, the provisioning risk data, and the transaction risk data; and
generate, at the monitoring cross layer, an alert message indicating at least one risk score associated with the account.

5. The system of claim 4, further comprising:
a user interface on a computing device configured to display at least one risk score generated based on the alert message, wherein the at least one risk score indicates a probability of the account being taken over by an unauthorized third party.

6. The system of claim 1,
wherein the patterns indicative of a fraudulent activity are associated with an account takeover.

7. The system of claim 1, wherein the account associated the access risk data, the provisioning risk data, and the transaction risk data corresponds to a merchant account.

8. A method for multi-layer risk detection of a takeover of an account, comprising:
generating, by a processor, access risk data at an access layer based on access layer data representing access data flow for accessing the account corresponding to merchant over a network, the access layer data associated with one or more login attempts to the account, the data comprising one or more of a number of login attempts, one or more Internet Protocol addresses from where the one or more login attempts originated, and device information associated with the one or more login attempts;
generating, by the processor, provisioning risk data at a provisioning layer based on provisioning layer data representing flows of at least one service associated with the account and the access risk data;
generating, by the processor, transaction risk data at a transaction layer based on transaction layer data representing transaction flows associated with the account, the access risk data, and the provisioning risk data; and
generating a risk notification based on one or more of the access risk data, the provisioning risk data, and the transaction risk data; and
transmitting the risk notification to a server associated with storing the account.

9. The method of claim 8, further comprising:
generating, at an authentication cross layer, an authentication message based on one or more of the access risk data, the provisioning risk data, and the transaction risk data wherein the authentication message indicates an unauthorized access to the account; and
transmitting the authentication message to an electronic address associated with the account, whereby a receipt of an electronic message activates an electronic message application and wherein the electronic message facilitates authentication of the account.

10. The method of claim 8, further comprising:
receiving, at a monitoring cross layer, the access risk data, the provisioning risk data, and the transaction risk data; and
generating, at the monitoring cross layer, an alert message indicating a risk score of the account, wherein the risk score indicates a risk of the takeover of the account.

11. The method of claim 10, further comprising:
regenerating, at the monitoring cross layer, the alert message at a predefined time interval, wherein the regenerated alert message is based on an updated access risk data, an updated provisioning risk data, and an updated transaction risk data.

12. The method of claim 11, further comprising:
receiving the regenerated alert message;
activating, in response to the received alert message, a user interface; and
displaying, on the user interface, an updated risk score included in the alert message, wherein the updated risk score is based on the updated access risk data, the updated provisioning risk data, and the updated transaction risk data.

13. The method of claim 8, further comprising:
analyzing, by a machine learning system, the access risk data, the provisioning risk data, and the transaction risk data to identify patterns indicative of an unauthorized takeover of the account.

14. The method of claim 8, wherein the at least one service includes an application for a service that requests funds to be transmitted to the account.

15. The method of claim 8, wherein the account is a merchant account.

16. A non-transitory computer-readable medium having instructions stored thereon, that, when executed by a processor, cause the processor to perform operations comprising:
receiving first layer data corresponding to at least one first event associated with an account, second layer data corresponding to at least one second event associated with the account, and third layer data corresponding to at least one third event associated with the account;
generating, using a first layer, first risk data from the first layer data, wherein the first layer data is associated with one or more login attempts to the account over a network, the first layer data comprising one or more of a number of login attempts, one or more Internet Protocol addresses from where the one or more login attempts originated, and device information associated with the one or more login attempts;
generating, using a second layer, second risk data from the second layer data and the first risk data;
generating, using a third layer, third risk data from the third layer data, the first risk data, and the second risk data; and
generating, a risk notification of a takeover of the account by an unauthorized party based on the first risk data, the second risk data, and the third risk data.

17. The non-transitory computer-readable medium of claim 16, the operations further comprising:
generating an authentication message based on the first risk data, the second risk data, and the third risk data, wherein the authentication message triggers an authentication mechanism using an electronic email address associated with the account.

18. The non-transitory computer-readable medium of claim 16, the operations further comprising:
generating, at predefined time intervals, an alert message based on the first risk data, the second risk data, and the third risk data, wherein the alert message includes a likelihood of the account being at risk of access by the unauthorized party.

19. The non-transitory computer-readable medium of claim 18, the operations further comprising:
transmitting the risk notification to a server associated with storing the account, wherein the risk notification triggers a mechanism for an additional overview of the account.

20. The non-transitory computer-readable medium of claim 16, wherein the second risk data indicates a likelihood of funds being transmitted into the account.
